(19) United States
(12) Patent Application Publication
(10) Pub. No.: US 2026/0140508 A1
(43) Pub. Date: May 21, 2026

(54) OBSTACLE AVOIDANCE METHOD, MOVEABLE DEVICE, AND COMPUTER

(71) Applicant: UBTECH ROBOTICS CORP LTD, Shenzhen (CN)

(72) Inventor: XIANGBIN HUANG, Shenzhen (CN)

(21) Appl. No.: 19/231,614

(22) Filed: Jun. 9, 2025

(30) Foreign Application Priority Data
Nov. 20, 2024 (CN) 202411678232.2

(51) Int. Cl. G05D 1/622; A47L 11/24; A47L 11/40; G01S 17/931; G05D 1/246; G05D 105/10

(52) U.S. Cl. CPC G05D 1/622; A47L 11/24; A47L 11/4002; A47L 11/4011; A47L 11/4061; G01S 17/931; G05D 1/246; A47L 2201/04; G05D 2105/10

(57) ABSTRACT

An obstacle avoidance method, a movable device, and a computer-readable storage medium are provided. The method includes: obtaining first coordinate of each obstacle in a map coordinate system; converting the first coordinate into second coordinate in a coordinate system of the movable device; calculating a distance between the second coordinate of the obstacle and an origin of the coordinate system, and an angle of the obstacle; determining whether the angle is in a first angle interval in response to the distance being less than or equal to the first detection radius to trigger a virtual collision in response to the angle being in the first angle interval; and determining whether the angle is in a second angle interval to trigger a virtual obstacle avoidance in response to the virtual collision being not triggered and the angle being in the second angle interval.

### CROSS REFERENCE TO RELATED APPLICATIONS

The present disclosure claims priority to Chinese Patent Application No. 202411678232.2, filed Nov. 20, 2024, which is hereby incorporated by reference herein as if set forth in its entirety.

### TECHNICAL FIELD

The present disclosure relates to obstacle avoidance technology, and particularly to an obstacle avoidance method, a movable device, and a computer-readable storage medium.

### BACKGROUND

Traditional sweeping machines mainly rely on front collision sensors for mechanical obstacle avoidances, and they can only react when encountering obstacles of low height and causing collisions during cleaning. Hence, there are more and more sweeping machines identify obstacles by mounting infrared sensors, line lasers, and surface laser sensors to perform collision-free cleaning using obstacle avoidance algorithms. The mainstream obstacle avoidance methods, for example, virtual path following, are not good enough in terms of following effect and smoothness because the path following relies on the path.

### BRIEF DESCRIPTION OF DRAWINGS

In order to more clearly illustrate the technical solution of the present disclosure, the drawings used in the embodiments of the present disclosure are introduced as follows. It should be noted that the following drawings only illustrate certain embodiments of the present disclosure and should not be regarded as limiting the scope of protection of the present disclosure. In each of the drawings, similar components are denoted with similar reference numerals.

FIG. 1 is a flow chart of a virtual obstacle avoidance method according to an embodiment of the present disclosure.

FIG. 2 is a schematic diagram of sensors for a sweeping machine and their positions according to an embodiment of the present disclosure.

FIG. 3 is a schematic diagram of obstacles and their first coordinate according to an embodiment of the present disclosure.

FIG. 4 is a flow chart of a virtual obstacle avoidance method according to another embodiment of the present disclosure.

FIG. 5 is a schematic diagram of a virtual obstacle avoidance range and a virtual collision range according to an embodiment of the present disclosure.

FIG. 6 is a schematic diagram of the rotational angle of a sweeping machine under a virtual collision according to an embodiment of the present disclosure.

FIG. 7 is a flow chart of a virtual obstacle avoidance method according to still another embodiment of the present disclosure.

FIG. 8 is a schematic diagram of the speed control of left and right wheels of a sweeping machine according to an embodiment of the present disclosure.

FIG. 9 is a schematic diagram of the structure of a virtual obstacle avoidance apparatus according to an embodiment of the present disclosure.

### DETAILED DESCRIPTION

The technical solutions in the embodiments of the present disclosure will be clearly and completely described below in conjunction with the drawings in the embodiments of the present disclosure. Apparently, the following embodiments are only part of the embodiments of the present disclosure, not all of the embodiments of the present disclosure.

The components of the embodiments of the present disclosure that are described and illustrated in the drawings herein may generally be arranged and designed in a variety of different configurations. Therefore, the following detailed description of the embodiments of the present disclosure provided in the drawings is not intended to limit the scope of the present disclosure, but merely represent the selected embodiments of the present disclosure. Based on the embodiments of the present disclosure, all other embodiments obtained by those of ordinary skill in the art without creative work fall within the protection scope of the present disclosure.

In the following, the terms “including”, “having” and their cognates that can be used in the embodiments of the present disclosure are only intended to indicate specific features, numbers, steps, operations, elements, components or their combinations, and should not be understood as for excluding the existence of one or more other features, numbers, steps, operations, elements, components or their combinations, or the possibility of increasing one or more features, numbers, steps, operations, elements, components or their combinations.

In addition, the terms “first”, “second”, “third”, and the like in the descriptions are only used for distinguishing, and cannot be understood as indicating or implying relative importance.

Unless otherwise defined, all terms (including technical terms and scientific terms) used herein have the same meaning as those generally understood by ordinary technicians in the field to which the embodiments of the present disclosure belong. The terms (e.g., those defined in generally used dictionaries) should be interpreted as having the same meaning as the contextual meaning in the relevant technical field and will not be interpreted as having an idealized meaning or an overly formal meaning unless clearly defined in the embodiments of the present disclosure.

### Embodiment 1

In this embodiment, a virtual obstacle avoidance method for a movable device such as a sweeping machine or a robot like a humanoid robot is provided.

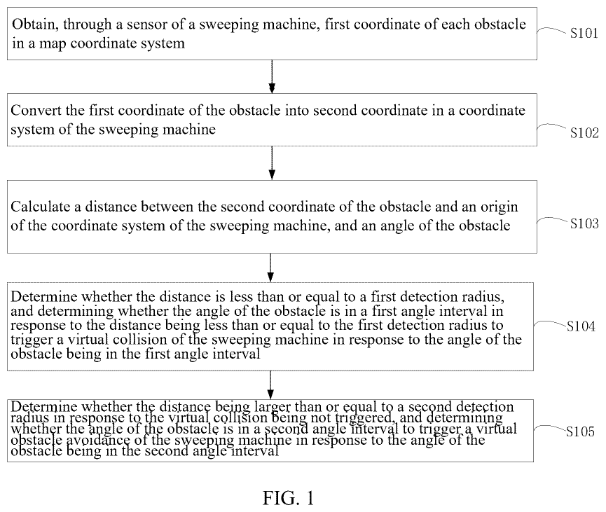

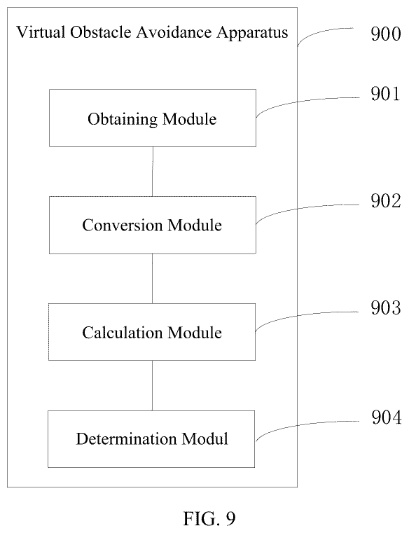

FIG. 1 is a flow chart of a virtual obstacle avoidance method according to an embodiment of the present disclosure. In this embodiment, the humanoid robot control method is applied to (a processor of) a sweeping machine having a sensor. In other embodiments, the method may be implemented through a virtual obstacle avoidance apparatus as shown in FIG. 9. As shown in FIG. 1, in this embodiment, the virtual obstacle avoidance method may include the following steps.
S101: obtaining, through the sensor of the sweeping machine, first coordinate of each obstacle in a map coordinate system.

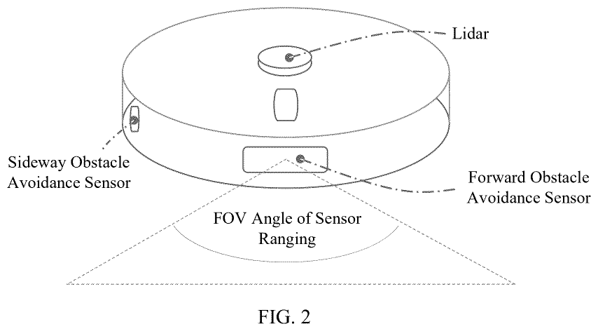

In this embodiment, the map coordinate system is a fixed global coordinate system, which is for marking the coordinates of the positions of all fixed obstacles on a map. In the map coordinate system, the positions of obstacles (e.g., walls) is constant, which facilitates the sweeping machine to carry out global path planning and navigation. FIG. 2 is a schematic diagram of sensors for a sweeping machine and their positions according to an embodiment of the present disclosure. As shown in FIG. 2, there are sensors installed on the sweeping machine for detecting obstacles in different directions, which include a forward obstacle avoidance sensor, a sideway obstacle avoidance sensor, and a lidar. The control system of the sweeping machine regularly triggers the tasks of obtaining the position information of obstacles within a preset distance around, where the frequency may be set as, for example, 30 times in 1 second according to real-time requirements. Each trigger will obtain and update the position information of the surrounding obstacles to store in an accessible array for subsequent path planning and obstacle avoidance strategies.

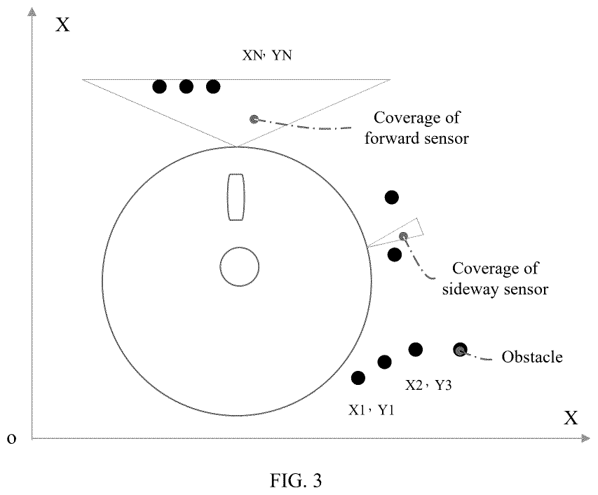

FIG. 3 is a schematic diagram of obstacles and their first coordinate according to an embodiment of the present disclosure. As shown in FIG. 3, the sensors detect and mark obstacles, where the first coordinate of the obstacles obtained by the sensor is (X,Y). The obstacles that are distant from the sweeping machine of exceeding a certain threshold (e.g., 50 cm) are filtered out to reduce unnecessary calculations. The first coordinate of all the obstacles that meet the condition is stored in an array with the format of [(X1, Y1), (X2, Y2), . . . , (XN, YN)].

In one embodiment, the S101 may include: obtaining, through the forward obstacle avoidance sensor, the first coordinate of the obstacle within a fixed distance in front of the sweeping machine; obtaining, through the sideway obstacle avoidance sensor, the first coordinate of obstacles within a fixed distance beside the sweeping machine; and obtaining, through the lidar, the first coordinate of the obstacle within a fixed distance above the sweeping machine

In this embodiment, it may obtain, through the forward obstacle avoidance sensor, obstacles in a certain angle range ahead of the sweeping machine; obtain, through the sideway obstacle avoidance sensor, obstacles in a certain angle range aside the sweeping machine; and obtain two-dimensional coordinate of obstacles in a fixed height above the sweeping machine by emitting a laser beam through the lidar to calculate a distance by measuring a reflection time of the laser beam.
S102: converting the first coordinate of the obstacle into second coordinate in a coordinate system of the sweeping machine.

In this embodiment, the map coordinate system provides a unified and standardized way to determine the information of obstacles. In the map coordinate system, each obstacle has a unique two-dimensional coordinate (X, Y). However, the sweeping machine usually cannot directly use (the first coordinate of) the map coordinates to calculate the distance from obstacles. Therefore, it is necessary to convert the coordinates of the obstacles in the map coordinate system to the coordinate system of the sweeping machine itself. Since the coordinates (i.e., the second coordinate) in the coordinate system of the sweeping machine directly reflect the position of the obstacle currently faced by the sweeping machine robot, which can be easily used to calculate the distance and direction between it and the obstacle so as to develop a more accurate and efficient obstacle avoidance strategy.

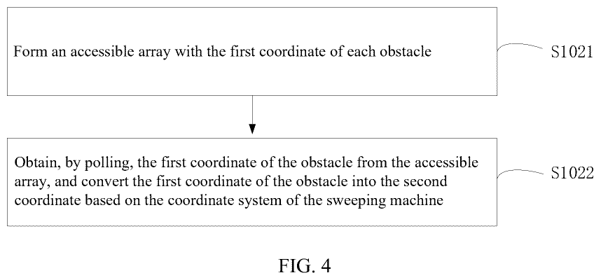

FIG. 4 is a flow chart of a virtual obstacle avoidance method according to another embodiment of the present disclosure. As shown in FIG. 4, in one embodiment, the S102 may include S1021-S1022:
S1021: forming an accessible array with the first coordinate of each obstacle.

In this embodiment, after obtaining the first coordinate of the obstacle in the map coordinate system, the first coordinate may be storage in an accessible array with the format of [(X1, Y1), (X2, Y2), . . . , (XN, YN)].
S1022: obtaining, by polling, the first coordinate of the obstacle from the accessible array, and converting the first coordinate of the obstacle into the second coordinate based on the coordinate system of the sweeping machine.

In this embodiment, as the sweeping machine moves, the coordinate system of the sweeping machine will also be moved and rotated. Since the coordinate system of the sweeping machine is a dynamic coordinate system, when converting the first coordinates of each obstacle to the second coordinates, it is necessary to determine the current position information of the sweeping machine under the map coordinate system, that is, the coordinates of the center of the sweeping machine (Xx, Yx). In addition to the position information, it is also necessary to determine the current orientation of the sweeping machine, that is, the rotational angle of the coordinate system of the sweeping machine relative to the map coordinate system. Based on the position and orientation information of the sweeping machine, a coordinate conversion formula may be applied to convert the map coordinates (Xi, Yi) of each obstacle polled from the accessed array to the coordinates (Xis, Yis) under the coordinate system of the sweeping machine.

Specifically, it subtracts position coordinates (Xx, Yx) of the sweeping machine from the first coordinate (Xi, Yi) of the obstacle to obtain an offset relative to the position of the sweeping machine, and rotates the offset according to the orient angle of the sweeping machine to obtain the second coordinate (Xis, Yis) under the coordinate system of the sweeping machine, that is, converting from [(X1, Y1), (X2, Y2), . . . , (XN, YN)] to [(X1s, Y1s), (X2s, Y2s), . . . , (XNs, YNs)].

In one embodiment, before converting the first coordinate of the obstacle into the second coordinate based on the coordinate system of the sweeping machine, the method may further include: determining the center of the sweeping machine; and constructing the coordinate system of the sweeping machine using the center of the sweeping machine as the origin, a right direction of the sweeping machine as the X-axis, and an upward direction of the sweeping machine as the Y-axis.

In this embodiment, the body of the sweeping machine is generally a circular area of a certain radius. By designing parameters, it determines the geometric center of the sweeping machine to construct the coordinate system of the sweeping machine using the geometric center of the sweeping machine as the origin, the right direction of the sweeping machine as the X-axis, and the upward direction of the sweeping machine as the Y-axis. As an example, constructing the coordinate system of the sweeping machine may further include constructing the coordinate system of the sweeping machine by using the geometric center of the sweeping machine as the origin, the left direction of the sweeping machine as the X-axis, and the upward direction of the sweeping machine as the Y-axis. By constructing the coordinate system of the sweeping machine, the sweeping machine can more easily determine how to avoid obstacles and how to plan the most effective cleaning path according to its position and orientation.
S103: calculating a distance between the second coordinate of the obstacle and the origin of the coordinate system of the sweeping machine, and an angle of the obstacle.

In this embodiment, the distance between the second coordinate of each obstacle and the origin of the coordinate system of the sweeping machine may be calculated based on equation (1): L=\sqrt{Xₖₛ×Xₖₛ+Yₖₛ×Yₖₛ}, where L is the distance, (Xₖₛ, Yₖₛ) are the second coordinate of the obstacles, and the origin of the coordinate system of the sweeping machine is (0, 0).

As an example, the angle of each obstacle may be calculated based on equation (2): θ=tan⁻2(Yₖₛ, Xₖₛ), where θ is the angle of the obstacle, and (Xₖₛ, Yₖₛ) is the second coordinate of the obstacle.
S104: determining whether the distance is less than or equal to a first detection radius, and determining whether the angle of the obstacle is in a first angle interval in response to the distance being less than or equal to the first detection radius to trigger a virtual collision of the sweeping machine in response to the angle of the obstacle being in the first angle interval.

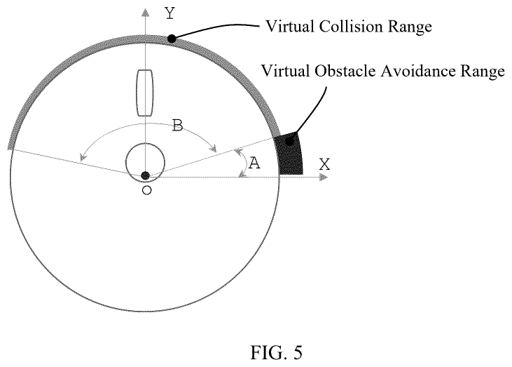

FIG. 5 is a schematic diagram of a virtual obstacle avoidance range and a virtual collision range according to an embodiment of the present disclosure. As shown in FIG. 5, the virtual collision range is a range of an included angle B (i.e., the first angle interval) from right to left that is from the right side of the sweeping machine, and the virtual obstacle avoidance range is a range of an included angle A (i.e., the second angle interval) from left to right that is in front of the sweeping machine. It polls out the coordinates (Xk, Yk) of each obstacle from the accessible array, converts the first information coordinates to the coordinate system of the sweeping machine with the center of the sweeping machine as the origin to obtain the second coordinate (Xks, Yks), and calculates the distance from the obstacle to the center of the sweeping machine using equation (1). If the distance is less than or equal to the first detection radius of the virtual collision, it calculates the angle of the obstacle according to equation (2) to determine whether the angle of the obstacle is within the first angle range. If so, the virtual collision is triggered. It should be noted that the first detection radius and the second detection radius are less than or equal to the radius of the circular area of the body of the sweeping machine.

In one embodiment, the trigger of the virtual collision may include: controlling the robot to stop moving; calculating a rotational direction and a rotational angle based on the second coordinate of the obstacle and a movement direction of the sweeping machine; and moving the sweeping machine according to the rotational direction and the rotational angle.

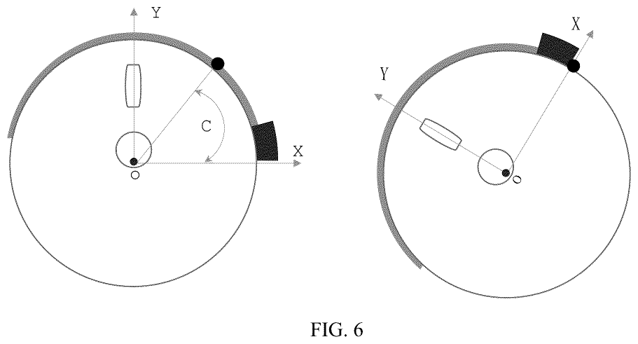

In this embodiment, when the sweeping machine detects that there is an obstacle in front and triggers the virtual collision, it will control its left wheel and right wheel to stop the current movement, and continue to determine the second coordinate of the obstacle and the current movement direction of the sweeping machine. If the obstacle is on the forward route of the sweeping machine and is on its right side, the sweeping machine will determine that the rotational direction is left to avoid the obstacle; on the contrary, if the obstacle is on its left side, the sweeping machine will choose to rotate to the right. Furthermore, based on the included angle between the second coordinate of the obstacle and the current travel route (i.e., moving direction) of the sweeping machine, the sweeping machine may use the built-in algorithm module to calculate the minimum rotational angle required to completely avoid the obstacle. FIG. 6 is a schematic diagram of the rotational angle C of the sweeping machine under a virtual collision according to an embodiment of the present disclosure.
S105: determining whether the distance being larger than or equal to a second detection radius in response to the virtual collision being not triggered, and determining whether the angle of the obstacle is in a second angle interval to trigger a virtual obstacle avoidance of the sweeping machine in response to the angle of the obstacle being in the second angle interval.

In this embodiment, the distance from the obstacle to the center of the sweeping machine is calculated through step S104. If the distance is larger than or equal to the second detection radius of the virtual obstacle avoidance, it calculates the angle of the obstacle using step S104 to determine whether the angle of the obstacle is within the second angle range. If the angle of the obstacle is within the second angle range, the virtual obstacle avoidance is triggered.

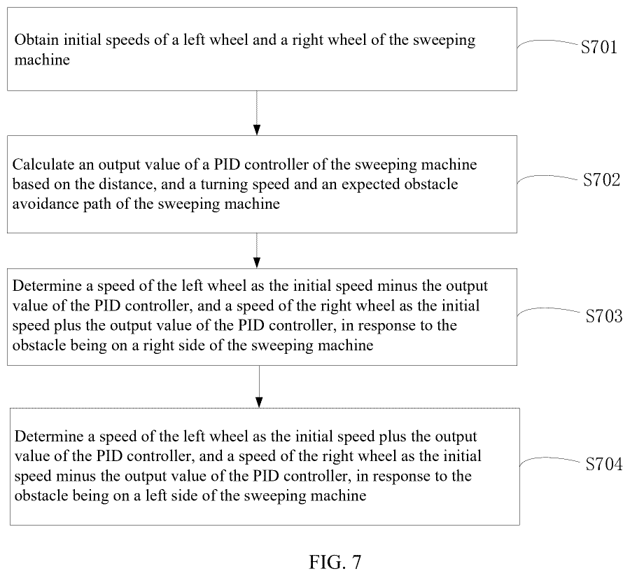

FIG. 7 is a flow chart of a virtual obstacle avoidance method according to still another embodiment of the present disclosure. As shown in FIG. 7, in one embodiment, the virtual obstacle avoidance method may include steps S701-S704.
S701: obtaining initial speeds of a left wheel and a right wheel of the sweeping machine.

In this embodiment, the control system of the sweeping machine may read the current speed of the left wheel and the right wheel through a sensor or an encoder, where the initial speed Vo (not shown) is used as the base speed for the subsequent speed adjustment by a PID (proportional-integral-differential) controller of the control system of the sweeping machine.
S702: calculating an output value of the PID controller of the sweeping machine based on the distance, and a turning speed and an expected obstacle avoidance path of the sweeping machine.

In this embodiment, the PID controller is a commonly used feedback controller. Through the method of step S103, the distance between the second coordinate of the obstacle and the position information of the sweeping machine itself is calculated to adjust an output value Vpid (not shown) based on the current distance, the turning speed, and the expected obstacle avoidance path, where the output value Vpid will be used to adjust the speed of the left wheel and the right wheel.
S703: determining a speed of the left wheel as the initial speed minus the output value of the PID controller, and a speed of the right wheel as the initial speed plus the output value of the PID controller, in response to the obstacle being on a right side of the sweeping machine.

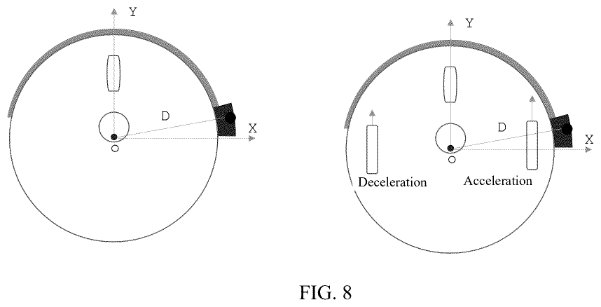

FIG. 8 is a schematic diagram of the speed control of left and right wheels of a sweeping machine according to an embodiment of the present disclosure. As shown in FIG. 8, in this embodiment, if the obstacle is on the right side of the sweeping machine, in order to generate a counterclockwise angular speed, the control system will reduce the speed of the left wheel. Specifically, the new speed of the left wheel will be equal to the initial speed minus the output value of the PID controller, that is, Vleft=Vo−Vpid, where Vleft is the new speed of the left wheel and Vo is the initial speed. At the same time, in order to maintain the stability of the sweeping machine and increase its ability to avoid obstacle, the control system will increase the speed of the right wheel, and the new speed of the right wheel will be equal to the initial speed plus the output value of the PID controller, that is, Vright=Vo+Vpid, where Vright is the new speed of the right wheel.
S704: determining a speed of the left wheel as the initial speed plus the output value of the PID controller, and a speed of the right wheel as the initial speed minus the output value of the PID controller, in response to the obstacle being on a left side of the sweeping machine.

In this embodiment, if the obstacle is on the left side of the sweeping machine, in order to generate a clockwise angular speed, the control system will increase the speed of the left wheel, and the new speed of the left wheel will be equivalent to the initial speed plus the output value of the PID controller, that is, Vleft=Vo+Vpid. At the same time, the control system will reduce the speed of the right wheel to Vright=Vo−Vpid.

In one embodiment, the method may further include: controlling the sweeping machine to move at a normal speed in response to the distance being larger than the first detection radius and less than the second detection radius; controlling sweeping machine to move at the normal speed in response to the distance being larger than the first detection radius and the angle of the obstacle being not in the second angle interval; controlling the sweeping machine to move at the normal speed in response to the angle of the obstacle being not in the first angle interval and the distance being less than the second detection radius; and controlling the sweeping machine to move at the normal speed in response to the angle of the obstacle being not in the first angle interval and not in the second angle interval.

In this embodiment, a condition based-on the above-mentioned distance may include: controlling the sweeping machine by maintaining normal speed regardless of the angle of the obstacle, in response to the distance being larger than the first detection radius and less than the second detection radius; and a condition based-on the above-mentioned angle may include: controlling the sweeping machine in normal speed, in response to the distance being larger than the first detection radius and the angle of the obstacle being not within the second angle range; controlling the sweeping machine in normal speed, in response to the angle of the obstacle being not in the first angle range and the distance being less than the second detection radius; and controlling the sweeping machine in normal speed, in response to the angle of the obstacle being not in the first angle range and that of the obstacle being not in the second angle range.

In this embodiment, the virtual obstacle avoidance method obtains, through a sensor, first coordinate information of each obstacle in a map coordinate system; convers the first coordinate information of the obstacle into second coordinate information in a coordinate system of the sweeping machine; calculates a distance between the second coordinate information of the obstacle and an origin of the coordinate system of the sweeping machine, and an angle of the obstacle; determines whether the distance is less than or equal to a first detection radius, and determining whether the angle of the obstacle is in a first angle interval in response to the distance being less than or equal to the first detection radius to trigger a virtual collision in response to the angle of the obstacle being in the first angle interval; and determines whether the distance being larger than or equal to a second detection radius in response to the virtual collision being not triggered, and determining whether the angle of the obstacle is in a second angle interval to trigger a virtual obstacle avoidance in response to the angle of the obstacle being in the second angle interval. By calculating the distance between the obstacle and the origin of the coordinate system of the sweeping machine, and setting different detection radiuses and angle intervals to select the virtual collision or the virtual obstacle avoidance for obstacle avoidance, the control of the sweeping machine is improved to have a smooth effect.

### Embodiment 2

In addition, the embodiments of the present disclosure provide a virtual obstacle avoidance apparatus 900, which is applied to a movable device like a sweeping machine.

FIG. 9 is a schematic diagram of the structure of a virtual obstacle avoidance apparatus according to an embodiment of the present disclosure. As shown in FIG. 9, the virtual obstacle avoidance apparatus 900 is applied to (a processor of) a sweeping machine having a senso, which may include:
an obtaining module 901 configured to obtain, through the sensor of the sweeping machine, first coordinate of each obstacle in a map coordinate system;
a conversion module 902 configured to convert the first coordinate of the obstacle into second coordinate in a coordinate system of the sweeping machine;
a calculation module 903 configured to calculate a distance between the second coordinate of the obstacle and an origin of the coordinate system of the sweeping machine, and an angle of the obstacle; and
a determination module 904 configured to determine whether the distance is less than or equal to a first detection radius, and determine whether the angle of the obstacle is in a first angle interval in response to the distance being less than or equal to the first detection radius to trigger a virtual collision of the sweeping machine in response to the angle of the obstacle being in the first angle interval.

In one embodiment, the determination module 904 may be further configured to control the sweeping machine to move at a normal speed in response to the distance being larger than the first detection radius and less than the second detection radius; control sweeping machine to move at the normal speed in response to the distance being larger than the first detection radius and the angle of the obstacle being not in the second angle interval; control the sweeping machine to move at the normal speed in response to the angle of the obstacle being not in the first angle interval and the distance being less than the second detection radius; and control the sweeping machine to move at the normal speed in response to the angle of the obstacle being not in the first angle interval and not in the second angle interval.

In one embodiment, the shown conversion module 902 may be further configured to form an accessible array with the first coordinate of each obstacle; and obtain, by polling, the first coordinate of the obstacle from the accessible array, and converting the first coordinate of the obstacle into the second coordinate based on the coordinate system of the sweeping machine.

In one embodiment, the shown conversion module 902 may be further configured to determine a center of the sweeping machine; and establish the coordinate system of the sweeping machine with the center of the sweeping machine as the origin of the coordinate system, a rightward direction of the sweeping machine as an X axis of the coordinate system, and an upward direction of the sweeping machine as a Y axis of the coordinate system.

In one embodiment, the calculation module 903 may be further configured to control the robot to stop moving; calculate a rotational direction and a rotational angle based on the second coordinate of the obstacle and a movement direction of the sweeping machine; and move the sweeping machine according to the rotational direction and the rotational angle.

In one embodiment, the calculation module 903 may be further configured to obtain initial speeds of a left wheel and a right wheel of the sweeping machine; calculate an output value of a PID controller of the sweeping machine based on the distance, and a turning speed and an expected obstacle avoidance path of the sweeping machine; determine a speed of the left wheel as the initial speed minus the output value of the PID controller, and a speed of the right wheel as the initial speed plus the output value of the PID controller, in response to the obstacle being on a right side of the sweeping machine; and determine a speed of the left wheel as the initial speed plus the output value of the PID controller, and a speed of the right wheel as the initial speed minus the output value of the PID controller, in response to the obstacle being on a left side of the sweeping machine.

In one embodiment, the obtaining module 901 may be further configured to obtain, through the forward obstacle avoidance sensor, the first coordinate of the obstacle within a fixed distance in front of the sweeping machine; obtain, through the sideway obstacle avoidance sensor, the first coordinate of obstacles within a fixed distance beside the sweeping machine; and obtain, through the lidar, the first coordinate of the obstacle within a fixed distance above the sweeping machine.

In this embodiment, the virtual obstacle avoidance apparatus 900 can realize the virtual obstacle avoidance method provided Embodiment 1. In order to avoid duplication, which will not be repeated herein.

In this embodiment, the virtual obstacle avoidance apparatus obtains, through a sensor, first coordinate information of each obstacle in a map coordinate system; convers the first coordinate information of the obstacle into second coordinate information in a coordinate system of the sweeping machine; calculates a distance between the second coordinate information of the obstacle and an origin of the coordinate system of the sweeping machine, and an angle of the obstacle; determines whether the distance is less than or equal to a first detection radius, and determining whether the angle of the obstacle is in a first angle interval in response to the distance being less than or equal to the first detection radius to trigger a virtual collision in response to the angle of the obstacle being in the first angle interval; and determines whether the distance being larger than or equal to a second detection radius in response to the virtual collision being not triggered, and determining whether the angle of the obstacle is in a second angle interval to trigger a virtual obstacle avoidance in response to the angle of the obstacle being in the second angle interval. By calculating the distance between the obstacle and the origin of the coordinate system of the sweeping machine, and setting different detection radiuses and angle intervals to select the virtual collision or the virtual obstacle avoidance for obstacle avoidance, the control of the sweeping machine is improved to have a smooth effect.

### Embodiment 3

Furthermore, the embodiments of the present disclosure provide an electronic device including a storage and a processor. The storage stores a computer program, and the virtual obstacle avoidance method in Embodiment 1 is performed when the computer program is executed on the processor. The electronic device may be a movable device like a sweeping machine.

In this embodiment, the electronic device can realize the virtual obstacle avoidance method provided Embodiment 1. In order to avoid duplication, which will not be repeated herein.

### Embodiment 4

Still furthermore, the embodiments of the present disclosure provide a computer-readable storage medium which stores a computer program, the virtual obstacle avoidance method in Embodiment 1 is performed when the computer program is executed on a processor.

In this embodiment, the computer-readable storage medium may be a read-only memory (ROM), a random access memory (RAM), a magnetic disk, an optical disk, or the like.

In this embodiment, the computer-readable storage medium can realize the virtual obstacle avoidance method provided Embodiment 1. In order to avoid duplication, which will not be repeated herein.

It should be noted that, in the present disclosure, the terms “comprising”, “including” or any other variation thereof are intended to encompass non-exclusive inclusion such that a process, method, article or terminal comprising a series of elements includes not only those elements, but also includes other elements not explicitly listed or inherent to the process, method, article or terminal s. Without further limitation, an element limited by the sentence “comprising a . . . ” does not preclude the existence of additional identical elements in a process, method, article or terminal that includes the element.

Through the forgoing description of the embodiments, those skilled in the art could clearly understand that the above-mentioned embodiments can be implemented through software and a necessary general hardware platform, or alternatively through hardware while in many cases the former is better choice. Based on this understanding, the technical solution of the present disclosure, either essentially or in part, contributes to the prior art, or a part of the technical solution can be embodied in the form of a software product which is stored in a storage medium (e.g., ROM/RAM, disk, and optical disc) including a plurality of instructions for causing a terminal (which may be a mobile phone, computer, server, air conditioner, network device, or the like) to perform the method described in various embodiments of the present disclosure.

Although the embodiments of the present disclosure have been described above in conjunction with the drawings, the present disclosure is not limited to the above-mentioned specific embodiments because those embodiments are only schematic and not restrictive. Hence, there are still many other variations can be made by those skilled in the art without departing from the purpose of the present disclosure and the scope of the claims, and all of those variations will fall within the scope of the present disclosure.

What is claimed is:

1. An obstacle avoidance method for a movable device having at least a sensor, comprising:
obtaining, through the sensor of the movable device, first coordinate of each obstacle in a map coordinate system;
converting the first coordinate of the obstacle into second coordinate in a coordinate system of the movable device;
calculating a distance between the second coordinate of the obstacle and an origin of the coordinate system of the movable device, and an angle of the obstacle;
determining whether the distance is less than or equal to a first detection radius, and determining whether the angle of the obstacle is in a first angle interval in response to the distance being less than or equal to the first detection radius to trigger a virtual collision of the movable device in response to the angle of the obstacle being in the first angle interval; and
determining whether the distance being larger than or equal to a second detection radius in response to the virtual collision being not triggered, and determining whether the angle of the obstacle is in a second angle interval to trigger a virtual obstacle avoidance of the movable device in response to the angle of the obstacle being in the second angle interval.

2. The method of claim 1, further comprising:
controlling the movable device to move at a normal speed in response to the distance being larger than the first detection radius and less than the second detection radius;
controlling movable device to move at the normal speed in response to the distance being larger than the first detection radius and the angle of the obstacle being not in the second angle interval;
controlling the movable device to move at the normal speed in response to the angle of the obstacle being not in the first angle interval and the distance being less than the second detection radius; and
controlling the movable device to move at the normal speed in response to the angle of the obstacle being not in the first angle interval and not in the second angle interval.

3. The method of claim 1, wherein converting the first coordinate of the obstacle into second coordinate in the coordinate system of the movable device comprises:
forming an accessible array with the first coordinate of each obstacle; and
obtaining, by polling, the first coordinate of the obstacle from the accessible array, and converting the first coordinate of the obstacle into the second coordinate based on the coordinate system of the movable device.

4. The method of claim 3, wherein before converting the first coordinate of the obstacle into second coordinate in the coordinate system of the movable device, the method further comprises:
determining a center of the movable device; and
establishing the coordinate system of the movable device with the center of the movable device as the origin of the coordinate system, a rightward direction of the movable device as an X axis of the coordinate system, and an upward direction of the movable device as a Y axis of the coordinate system.

5. The method of claim 1, wherein trigger the virtual collision of the movable device comprises:
controlling the robot to stop moving;
calculating a rotational direction and a rotational angle based on the second coordinate of the obstacle and a movement direction of the movable device; and
moving the movable device according to the rotational direction and the rotational angle.

6. The method of claim 1, wherein trigger the virtual obstacle avoidance of the movable device comprises:
obtaining initial speeds of a left wheel and a right wheel of the movable device;
calculating an output value of a PID controller of the movable device based on the distance, and a turning speed and an expected obstacle avoidance path of the movable device;
determining a speed of the left wheel as the initial speed minus the output value of the PID controller, and a speed of the right wheel as the initial speed plus the output value of the PID controller, in response to the obstacle being on a right side of the movable device; and
determining a speed of the left wheel as the initial speed plus the output value of the PID controller, and a speed of the right wheel as the initial speed minus the output value of the PID controller, in response to the obstacle being on a left side of the movable device.

7. The method of claim 1, wherein the sensor includes a forward obstacle avoidance sensor, a sideway obstacle avoidance sensor, and a lidar; and obtaining, through the sensor of the movable device, first coordinate of the obstacle in the map coordinate system comprises:
obtaining, through the forward obstacle avoidance sensor, the first coordinate of the obstacle within a fixed distance in front of the movable device;
obtaining, through the sideway obstacle avoidance sensor, the first coordinate of obstacles within a fixed distance beside the movable device; and
obtaining, through the lidar, the first coordinate of the obstacle within a fixed distance above the movable device.

8. A movable device, comprising:
at least a sensor;
a processor;
a memory coupled to the processor; and
one or more computer programs stored in the memory and executable on the processor;
wherein, the one or more computer programs comprise:
instructions for obtaining, through the sensor of the movable device, first coordinate of each obstacle in a map coordinate system;
instructions for converting the first coordinate of the obstacle into second coordinate in a coordinate system of the movable device;
instructions for calculating a distance between the second coordinate of the obstacle and an origin of the coordinate system of the movable device, and an angle of the obstacle;
instructions for determining whether the distance is less than or equal to a first detection radius, and determining whether the angle of the obstacle is in a first angle interval in response to the distance being less than or equal to the first detection radius to trigger a virtual collision of the movable device in response to the angle of the obstacle being in the first angle interval; and
instructions for determining whether the distance being larger than or equal to a second detection radius in response to the virtual collision being not triggered, and determining whether the angle of the obstacle is in a second angle interval to trigger a virtual obstacle avoidance of the movable device in response to the angle of the obstacle being in the second angle interval.

9. The movable device of claim 8, wherein the one or more computer programs further comprises:
instructions for controlling the movable device to move at a normal speed in response to the distance being larger than the first detection radius and less than the second detection radius;
instructions for controlling movable device to move at the normal speed in response to the distance being larger than the first detection radius and the angle of the obstacle being not in the second angle interval;
instructions for controlling the movable device to move at the normal speed in response to the angle of the obstacle being not in the first angle interval and the distance being less than the second detection radius; and
controlling the movable device to move at the normal speed in response to the angle of the obstacle being not in the first angle interval and not in the second angle interval.

10. The movable device of claim 8, wherein the instructions for converting the first coordinate of the obstacle into second coordinate in the coordinate system of the movable device comprise:
instructions for forming an accessible array with the first coordinate of each obstacle; and
instructions for obtaining, by polling, the first coordinate of the obstacle from the accessible array, and converting the first coordinate of the obstacle into the second coordinate based on the coordinate system of the movable device.

11. The movable device of claim 10, wherein the one or more computer programs further comprises:
instructions for determining a center of the movable device; and
instructions for establishing the coordinate system of the movable device with the center of the movable device as the origin of the coordinate system, a rightward direction of the movable device as an X axis of the coordinate system, and an upward direction of the movable device as a Y axis of the coordinate system.

12. The movable device of claim 8, wherein trigger the virtual collision of the movable device comprises:
controlling the robot to stop moving;
calculating a rotational direction and a rotational angle based on the second coordinate of the obstacle and a movement direction of the movable device; and
moving the movable device according to the rotational direction and the rotational angle.

13. The movable device of claim 8, wherein trigger the virtual obstacle avoidance of the movable device comprises:
obtaining initial speeds of a left wheel and a right wheel of the movable device;
calculating an output value of a PID controller of the movable device based on the distance, and a turning speed and an expected obstacle avoidance path of the movable device;
determining a speed of the left wheel as the initial speed minus the output value of the PID controller, and a speed of the right wheel as the initial speed plus the output value of the PID controller, in response to the obstacle being on a right side of the movable device; and
determining a speed of the left wheel as the initial speed plus the output value of the PID controller, and a speed of the right wheel as the initial speed minus the output value of the PID controller, in response to the obstacle being on a left side of the movable device.

14. The movable device of claim 8, wherein the sensor includes a forward obstacle avoidance sensor, a sideway obstacle avoidance sensor, and a lidar; and the instructions for obtaining, through the sensor of the movable device, first coordinate of the obstacle in the map coordinate system comprise:
instructions for obtaining, through the forward obstacle avoidance sensor, the first coordinate of the obstacle within a fixed distance in front of the movable device;
instructions for obtaining, through the sideway obstacle avoidance sensor, the first coordinate of obstacles within a fixed distance beside the movable device; and
instructions for obtaining, through the lidar, the first coordinate of the obstacle within a fixed distance above the movable device.

15. A non-transitory computer-readable storage medium for storing one or more computer programs, wherein the one or more computer programs comprise:
instructions for obtaining, through a sensor of a movable device, first coordinate of each obstacle in a map coordinate system;
instructions for converting the first coordinate of the obstacle into second coordinate in a coordinate system of the movable device;
instructions for calculating a distance between the second coordinate of the obstacle and an origin of the coordinate system of the movable device, and an angle of the obstacle;
instructions for determining whether the distance is less than or equal to a first detection radius, and determining whether the angle of the obstacle is in a first angle interval in response to the distance being less than or equal to the first detection radius to trigger a virtual collision of the movable device in response to the angle of the obstacle being in the first angle interval; and
instructions for determining whether the distance being larger than or equal to a second detection radius in response to the virtual collision being not triggered, and determining whether the angle of the obstacle is in a second angle interval to trigger a virtual obstacle avoidance of the movable device in response to the angle of the obstacle being in the second angle interval.

16. The storage medium of claim 15, wherein the one or more computer programs further comprises:
instructions for controlling the movable device to move at a normal speed in response to the distance being larger than the first detection radius and less than the second detection radius;
instructions for controlling movable device to move at the normal speed in response to the distance being larger than the first detection radius and the angle of the obstacle being not in the second angle interval;
instructions for controlling the movable device to move at the normal speed in response to the angle of the obstacle being not in the first angle interval and the distance being less than the second detection radius; and
controlling the movable device to move at the normal speed in response to the angle of the obstacle being not in the first angle interval and not in the second angle interval.

17. The storage medium of claim 15, wherein the instructions for converting the first coordinate of the obstacle into second coordinate in the coordinate system of the movable device comprise:
instructions for forming an accessible array with the first coordinate of each obstacle; and
instructions for obtaining, by polling, the first coordinate of the obstacle from the accessible array, and converting the first coordinate of the obstacle into the second coordinate based on the coordinate system of the movable device.

18. The storage medium of claim 17, wherein the one or more computer programs further comprises:
instructions for determining a center of the movable device; and
instructions for establishing the coordinate system of the movable device with the center of the movable device as the origin of the coordinate system, a rightward direction of the movable device as an X axis of the coordinate system, and an upward direction of the movable device as a Y axis of the coordinate system.

19. The storage medium of claim 15, wherein trigger the virtual collision of the movable device comprises:
controlling the robot to stop moving;
calculating a rotational direction and a rotational angle based on the second coordinate of the obstacle and a movement direction of the movable device; and
moving the movable device according to the rotational direction and the rotational angle.

20. The storage medium of claim 15, wherein trigger the virtual obstacle avoidance of the movable device comprises:
obtaining initial speeds of a left wheel and a right wheel of the movable device;
calculating an output value of a PID controller of the movable device based on the distance, and a turning speed and an expected obstacle avoidance path of the movable device;
determining a speed of the left wheel as the initial speed minus the output value of the PID controller, and a speed of the right wheel as the initial speed plus the output value of the PID controller, in response to the obstacle being on a right side of the movable device; and
determining a speed of the left wheel as the initial speed plus the output value of the PID controller, and a speed of the right wheel as the initial speed minus the output value of the PID controller, in response to the obstacle being on a left side of the movable device.
